(19) United States
(12) Patent Application Publication
(10) Pub. No.: US 2012/0311240 A1
(43) Pub. Date: Dec. 6, 2012

(54) INFORMATION PROCESSING APPARATUS, INFORMATION PROCESSING METHOD, AND STORAGE MEDIUM

(75) Inventor: Kensuke Kato, Tokyo (JP)

(73) Assignee: CANON KABUSHIKI KAISHA, Tokyo (JP)

(21) Appl. No.: 13/484,125

(22) Filed: May 30, 2012

(30) Foreign Application Priority Data
Jun. 3, 2011 (JP) 2011-125345

(51) Int. Cl. G06F 12/00

(52) U.S. Cl. 711/103; 711/E12.008

(57) ABSTRACT

The hibernation start-up by the kernel function takes a long time due to a processing time required for a normal boot sequence. When starting an operating system, the information processing apparatus according to the present invention determines whether to perform the hibernation start-up processing before initialization of a memory management mechanism. When the hibernation start-up processing is performed, a size of the memory management mechanism is reduced to a minimum size necessary for initializing the kernel and a hibernation image is read in parallel with initialization of hardware. The limited memory management area can be restored to a state free from a limitation by reading the hibernation image.

### BACKGROUND OF THE INVENTION

1. Field of the Invention

The present invention relates to a technique for starting an information apparatus including a hibernation mechanism at high speed.

2. Description of the Related Art

In recent years, hibernation utilized in an information processing apparatus has drawn attention that can reduce power consumption when the information processing apparatus is in a standby state. The hibernation is a mechanism for interrupting a system. Upon hibernation, information pieces included in a memory or a central processing unit (CPU) register (hereinafter, referred to as a “hibernation image”) are saved into a non-volatile storage apparatus, such as a hard disk, during the system is running. If a power is turned off subsequently, when the system is started next, the same state can be restored as before by reading the hibernation image (hereinafter, referred to as “hibernation start-up”). The hibernation may be used for the purpose of reducing a starting time of the system.

The hibernation start-up is roughly classified into two types. One is a method for performing restoration by a basic input/output system (BIOS) function or a boot reader function and the other is a method for performing restoration by a kernel function of an operating system.

When the hibernation start-up is performed by the kernel function, the system state can be restored by reading the hibernation image previously stored in the non-volatile storage apparatus after the kernel is almost completely initialized. Compared the hibernation by the kernel function with that by the BIOS function, since a device is initialized by executing a normal boot sequence, the hibernation by the kernel function is excellent in general versatility and can easily make various types of device drivers responsive to the hibernation.

However, the hibernation by the kernel function, compared with the hibernation by the BIOS function or the boot reader function, needs a processing time for the boot sequence, and thus takes a long starting time.

As described in Japanese Patent Application Laid-Open No. 2010-157017, the starting time may be reduced by removing a device that does not need to be initialized at the time of the hibernation start-up from an initialization target. However, the device which is removed from the initialization target needs to be selected, so that the versatility may be lost.

Generally, if a direct memory access (DMA) controller is used, information can be read and written among storage apparatuses in parallel with specific processing. If the DMA mechanism can be incorporated to the hibernation start-up, the hibernation image can be previously read in parallel with initialization of the kernel, so that the time for the hibernation start-up can be reduced.

However, on the kernel which includes a complicated memory management mechanism such as Linux (registered trademark), the DMA controller cannot write data into an arbitrary address in a memory area managed by the kernel. Thus, by the conventional hibernation start-up method, reading the hibernation image in parallel with the initialization of the kernel is difficult.

### SUMMARY OF THE INVENTION

According to one aspect of the present invention, there is provided an information processing apparatus includes a volatile memory, a non-volatile memory configured to store hibernation information, and a reading unit configured to, in parallel with initialization of a kernel expanded in the volatile memory, read a part of the hibernation information stored in the non-volatile memory into an area that is not used for initialization of the kernel.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 schematically illustrates a configuration of an information processing apparatus.

FIG. 2 illustrates a functional relationship in a hibernation mechanism according to an exemplary embodiment of the present invention.

FIG. 3 is a flowchart illustrating processing for creating a hibernation image.

FIG. 4 illustrates an example of a format of a hibernation image.

FIG. 5 is a flowchart illustrating processing for starting a system.

FIG. 6 illustrates a difference between an access area in a kernel and that in a DMA controller.

FIG. 7 is a flowchart illustrating processing for restoring a hibernation image.

### DESCRIPTION OF THE EMBODIMENTS

Various exemplary embodiments, features, and aspects of the invention will be described in detail below with reference to the drawings.

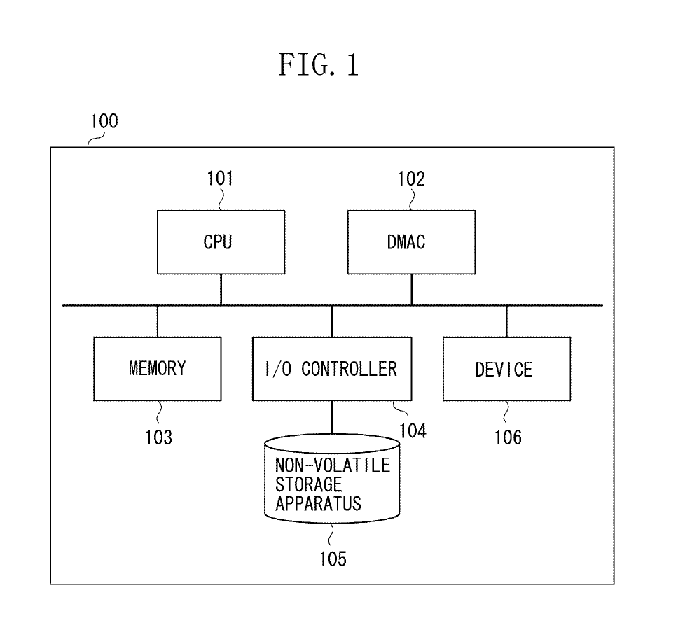

FIG. 1 illustrates a usage example of an information processing apparatus to which a first exemplary embodiment of the present invention can be applied.

In FIG. 1, an information processing apparatus 100 includes a central processing unit (CPU) 101 and a direct memory access controller (DMAC) 102. A memory 103 includes an inexpensive and large-capacity volatile memory such as a dynamic random access memory (DRAM) (e.g., synchronous dynamic random access memory (SDRAM)). The CPU 101 or the DMAC 102 reads/writes data from/into the memory 103. Further, the information processing apparatus 100 includes an input/output control unit 104 (hereinbelow, referred to as an I/O controller) and a non-volatile storage apparatus 105 (e.g., a flash memory, a hard disk drive (HDD), and a solid state drive (SSD)).

The CPU 101 reads a program in a read only memory (ROM) (not illustrated) into the memory 103 and fetches the program from the memory 103 to execute processing described below.

A hibernation image created by the hibernation is stored in the non-volatile storage apparatus 105, and read/written via the I/O controller 104. A device 106 is initialized by the CPU 101. One or more devices 106 may be included in the information processing apparatus 100.

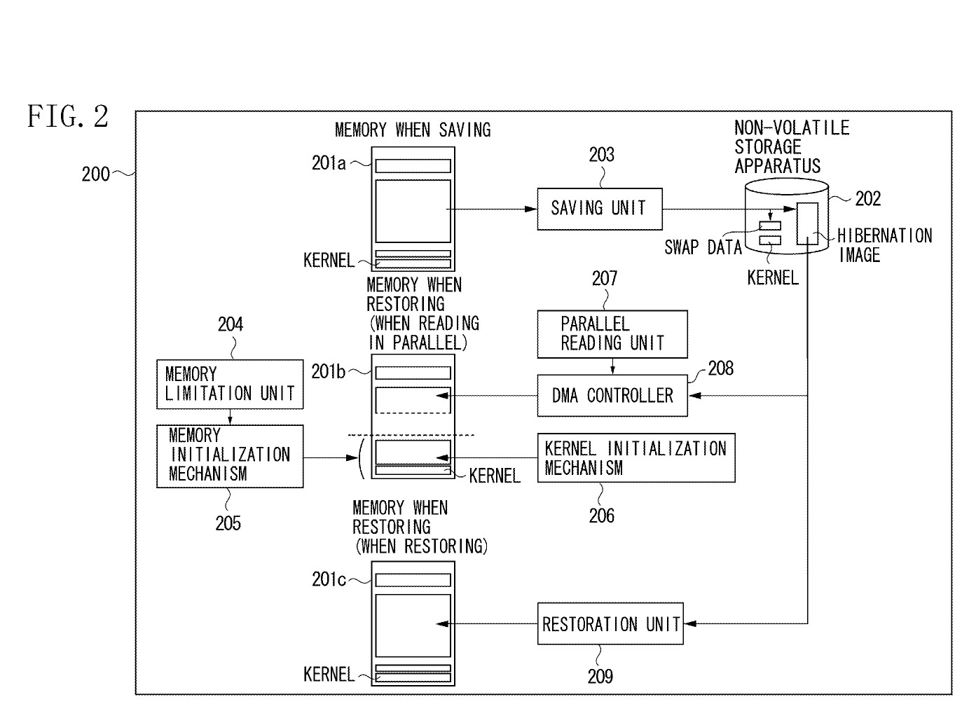

FIG. 2 illustrates a configuration of a hibernation mechanism according to an exemplary embodiment of the present invention. In the hibernation mechanism 200, memories 201a, 201b, and 201c represent the same memory. The memory 201a represents the memory when a hibernation image is saved. The memory 201b represents the memory when parallel reading is performed. The memory 201c represents the memory when the hibernation image is restored after the parallel reading. A non-volatile storage apparatus 202 stores the hibernation image. The non-volatile storage apparatus 202 stores a kernel code, the hibernation image, and swap data.

The hibernation mechanism 200 includes a saving unit 203. When a user requests a system to shift to an interruption state, the saving unit 203 outputs the hibernation image, the swap data, and the data in the memory 201a to the non-volatile storage apparatus 202.

The hibernation mechanism 200 includes a memory limitation unit 204 and a memory initialization mechanism 205. The memory limitation unit 204 limits a memory area size that can be used by an operating system with respect to the memory initialization mechanism 205. The memory initialization mechanism 205 initializes the memory 201b based on the information about the limitation. The hibernation mechanism 200 also includes a kernel initialization mechanism 206. Based on the kernel code stored in the non-volatile storage apparatus 202, the kernel initialization mechanism 206 initializes the kernel using a kernel management area which is initialized by the memory initialization mechanism 205 of the memory 201b.

The hibernation mechanism 200 further includes a parallel reading unit 207 and a DMAC 208. The parallel reading unit 207 reads the hibernation image stored in the non-volatile storage apparatus 202 in parallel with initialization processing of the kernel initialization mechanism 206 using the DMAC 208. A destination of outputting the hibernation image of the DMA controller 208 by the parallel reading unit 207 during the initialization processing is limited to a kernel non-management area that is not initialized by the memory initialization mechanism 205.

A restoration unit 209 reads the hibernation image, which is not read by the parallel reading unit 207 from the non-volatile storage apparatus 202 to the memory 201c, into the kernel non-management area and the kernel management area. The restoration unit 209 reads each of hibernation image, and thus the memory 201c can be restored back to a state of the memory 201a except for a part of data.

According to the present exemplary embodiment, speeding up of the hibernation start-up will be described using Linux (registered trademark) version 2.6.18 as a conventional method.

A flow for creating a hibernation image according to the present exemplary embodiment will be described.

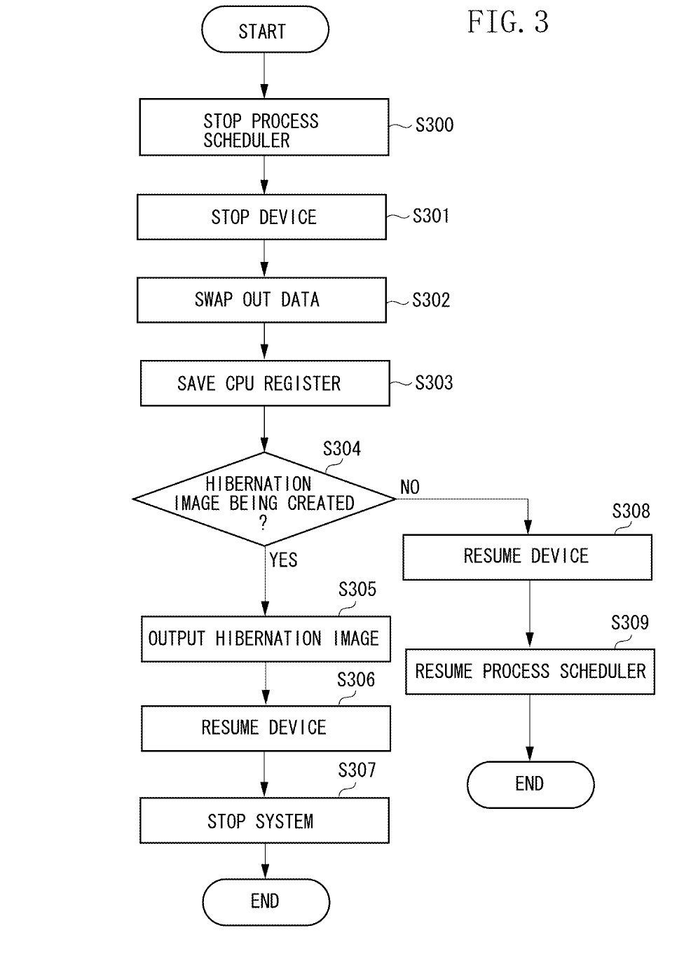

FIG. 3 is a flowchart illustrating a flow from when the system is requested to shift to the interruption state to when the system is stopped. In step S300, a process scheduler is stopped. In step S302, each device is stopped. In step S302, data is swapped out. In step S303, the CPU register is saved.

In step S304, it is determined whether the hibernation image is being created. Normally, since the hibernation image is being created (YES in step S304), the processing proceeds to step S305. A case where the processing proceeds to step S308 is a case where the system is restored to a state immediately after the processing in step S303 by the hibernation start-up, which will be described below in detail.

In step S305, the hibernation image is output. In step S306, each device is resumed. Then in step S307, the system is stopped.

On the other hand, in step S308, each device is resumed and, in step S309, the process scheduler is resumed. The processing in step S306 is same as that in step S308.

The user (or a user application) accesses a virtual file system to request the system to shift to the interruption state. For executing the processing in steps S300, S301, S302, S306, S307, S308, and S309, the conventional function included in Linux (registered trademark) is used.

In step S302, the data related to the process expanded in the memory is previously swapped out from the memory to a swap area of the non-volatile storage apparatus, so that a work area can be ensured, a size of the hibernation image is reduced, and an starting time can be shortened. The user (or the user application) previously accesses the virtual file system to specify a size of swapping out the data.

In step S303, the processing is performed within a special function. When a value of a CPU general-purpose data register that needs to be written back when returning from the function is saved into a variable on the memory as a parameter, and in an x86 processor, registers esp, ebx, ebp, esi, and edi correspond thereto. At the time of restoration, the values are written back to the memory and the above-described CPU register to return from the function, and the function can be restored to the one executed before the system is stopped.

In step S305, the data remaining on the memory is output to the non-volatile storage apparatus as the hibernation image.

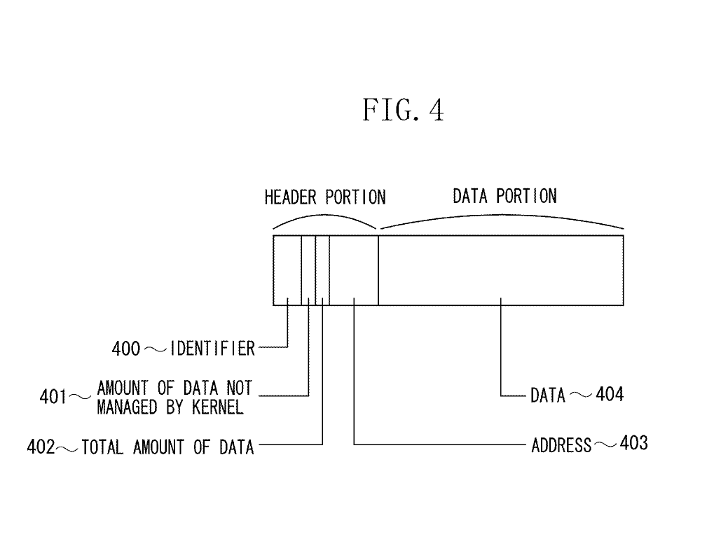

FIG. 4 illustrates a format of the hibernation image as an example of hibernation information. An identifier 400 indicates whether the hibernation image is valid. An amount of data not managed by the kernel 401 indicates an amount of data pieces included in the kernel non-management area. A total data amount 402 indicates a total amount of the data pieces included in both of the kernel management area and the kernel non-management area. An address 403 stores a group of addresses of the hibernation image. Data 404 stores a group of data of the hibernation image. A header portion includes the identifier 400, the amount of data not managed by the kernel 401, the total data amount 402, and the address 403, and a data portion includes the data 404.

The data 404 stores data on the memory 103 by the page. However, the data 404 does not include the kernel code area, a global variable related to the hibernation processing (hereinbelow, referred to as a “hibernation global variable”) and the swap out data. The address 403 and the data 404 have a corresponding relationship to each other, and a location destination of N-th stored data in the data 404 is an N-th stored address in the address 403. An amount of information pieces in the address 403 and an amount of data in the data 404 are each equal to the total data amount 402 respectively.

With respect to the data to be stored in association with the address 403 and the data 404, it is desirable that the data in the kernel non-management area is arranged in the front and the data in the kernel management area is arranged at the back thereof. The purpose of this arrangement is to prevent the data from being restored in the kernel management memory when the kernel is initialized. The parallel reading unit 207 limits the amount of readable data to the amount of data not managed by the kernel 401, and thus the parallel reading unit 207 reads only the data in the front portion of the data 404 so as not to read the data into the kernel management memory.

The hibernation image is sequentially stored from a specific sector to an area (non-partition area) that is not defined as a partition for the convenience of the hibernation start-up. Thus, it is desirable that a sector number is directly set in the kernel code area in advance. Further, since the device is stopped, the data cannot be output to the non-volatile storage apparatus using the function of Linux (registered trademark). Thus, a special output mechanism is added to the kernel code area to perform the output of the data to the non-volatile storage apparatus using the special output mechanism.

Next, the flow of the hibernation start-up according to the present exemplary embodiment will be described.

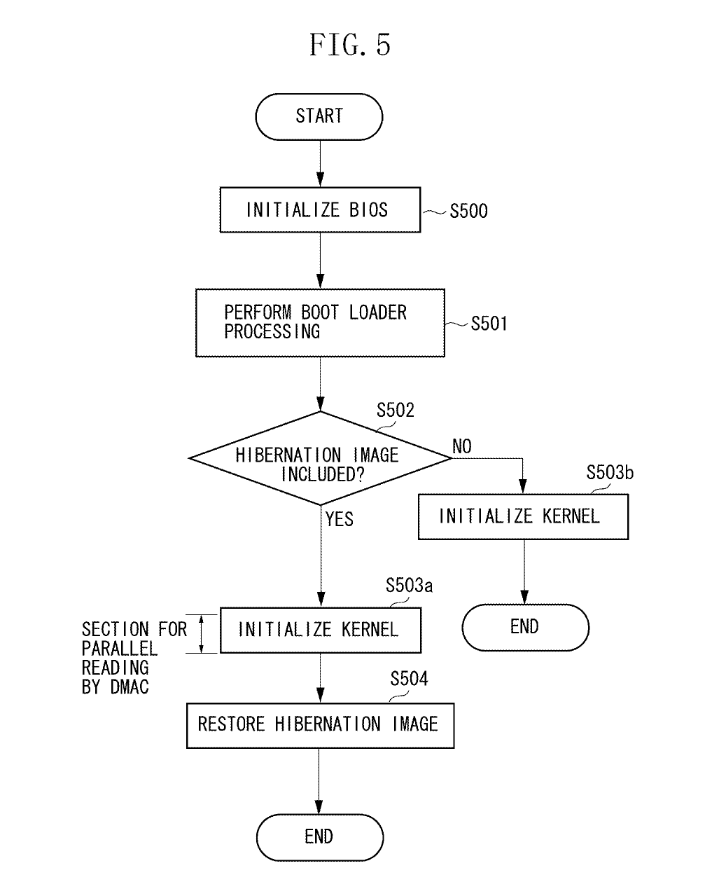

FIG. 5 is a flowchart illustrating from when the information processing apparatus is turned on to when the system is started. In step S500, the BIOS is initialized. In step S501, a boot loader loads and expands the kernel.

In step S502, it is checked whether the hibernation image is stored in the non-volatile storage apparatus 105. If the hibernation image is stored (YES in step S502), then instep S503a, the kernel is initialized. In step S504, the hibernation image is restored and then the hibernation start-up is completed. In step S503a, the parallel reading is performed by the DMAC in parallel with the kernel initialization.

If the hibernation image is not stored (NO in step S502), in step S503b, to normally start the system, the kernel is initialized and the starting of the system is completed.

Processing in steps S502 and S504 may be performed as a part of the kernel initialization processing.

In step S502, the DMAC is initialized, the header portion of the hibernation image is read into the memory 103 from an area in which a specific sector of the non-volatile storage apparatus, which is to be a hibernation image storage destination, is on a leading position, and then whether the hibernation image is stored is checked by the processing of the CPU 101. The header portion is preferably read into a hibernation global variable to avoid it from being overwritten when it is restored. When predetermined information is written into the identifier 400, it can determined that the hibernation image is stored in the non-volatile storage apparatus (YES in step S502). Then the information about the identifier 400 of the non-volatile storage apparatus is cleared, and the hibernation start-up is started.

On the other hand, when it is determined that the hibernation image is not stored in the non-volatile storage apparatus (NO in step S502), in step S503b, the kernel is initialized to normally start the system.

The hibernation mechanism unique to Linux (registered trademark) reads the hibernation image after initialization of the kernel function is completed. Thus, when the hibernation image is read using the kernel function, partition information and file information about the non-volatile storage apparatus can be used.

However, since the method according to the present exemplary embodiment starts reading the hibernation image in parallel with starting the kernel initialization, the above-described partition information cannot be used. Therefore, it is desirable that the non-volatile storage apparatus is provided with an area that is not separated by the partition information (area that is not defined by the partition information), and the hibernation image is stored in this area by being converted into data with a unique format which is independent of a file system.

The initialization of the kernel in step S503a has roughly two differences, compared with the initialization without using the hibernation image in step S503b.

A first difference is that a limit is imposed on a memory size that the system (kernel) to be initialized can use. In the initialization by the memory management mechanism in Linux (registered trademark), the initialization of the memory is performed based on a memory map obtained from the BIOS. On the other hand, according to the present exemplary embodiment, before the initialization of the memory is performed using the function of Linux (registered trademark), the memory map is re-written.

When the memory is re-written, a specific value (address) can be specified, and thus it can be set that only the memory area up to the specific value (address) can be used by the kernel. As the specific value, it is desirable that a minimum size necessary as the work area for completing the initialization of the kernel (initialization of the system) or more may be specified. The size of the changed area (memory map) does not need to be restored by specific processing since it does not affect the operation after the system is restored. This is because, by reading the hibernation image, the data regarding the area size is overwritten. It is desirable that the information for setting the above-described memory area to be used by the kernel (hereinafter, referred to as a “kernel management area”) is directly set in the code area of the kernel.

By the above-described processing, the two types of areas including the kernel management area and the kernel non-management area are secured in the memory 103. When the memory having the sufficient size compared with a limit size is mounted, the size of the kernel management area becomes equal to the limit size, and the size obtained by subtracting the kernel management area from the whole size of the memory corresponds to the kernel non-management area (further another area may be provided). However, when the memory is not sufficiently mounted compared with the limit size, the kernel non-management area is not secured.

Next, a second difference is to read the hibernation image from the non-volatile storage apparatus 105 into the memory 103 in parallel with the kernel initialization.

Using the DMAC as a parallel reading means, the hibernation image is read into the memory so as to restore the memory arrangement immediately before the hibernation image is saved. However, if it is tried to restore the hibernation image in the whole memory area at once, since the kernel management area is used to initialize the kernel, there is a risk that the code to be used in the initialization processing is overwritten. Thus, at a stage in the parallel reading unit, the hibernation image is read into the kernel non-management area where the memory has not been initialized. Therefore, when the kernel non-management area is not secured, the parallel reading is not performed.

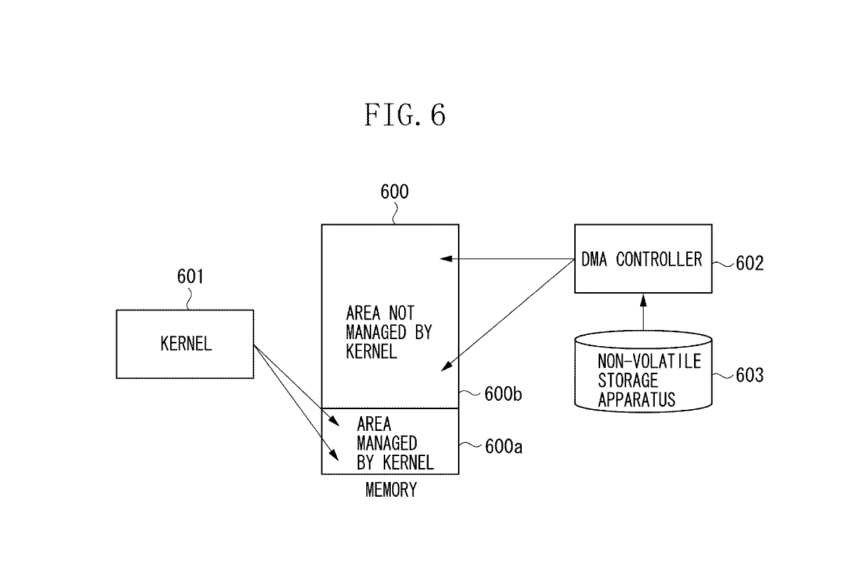

FIG. 6 illustrates the parallel reading. A memory 600 includes a kernel management area 600a and a kernel non-management area 600b. A kernel 601 is executed only by the CPU 101, which only accesses the kernel management area 600a. FIG. 6 illustrates a DMAC 602 and a non-volatile storage apparatus 603. The DMAC 602 transfers the hibernation image only to the kernel non-management area 600b during the initialization of the kernel.

When specifying the parameters (a transfer source address, a transfer destination address, and a data size) to be used for transferring the data by the CPU 101, the DMAC 602 transfers the data from the non-volatile storage apparatus 603 to the memory asynchronously with the CPU, with a predetermined size set as a maximum size. After the output of the data is completed, a new parameter needs to be specified again by the CPU 101. It is desirable that the DMAC 602 is set to interrupt the CPU 101 using completion of the transfer of the data with the predetermined size as a trigger and specifies the data to be read next based on the address 403 to newly perform reading.

In addition, the interruption may be generated at regular time intervals using a local Advanced Programmable Interrupt Controller (APIC) timer, and the CPU 101 may check the reading state of the DMAC 602. If reading has been completed, the data to be read next may be specified based on the address 403 and the DMAC 602 may newly perform reading.

The DMAC 602 continues the parallel reading of the hibernation image until the DMAC 602 finishes reading of all hibernation images to be read into the kernel non-management area, or just before the DMAC 602 starts to read the hibernation image into either of the kernel management area or the kernel non-management area after the initialization of the kernel finishes.

However, during the initialization of the advanced technology attachment (ATA), the transfer by the DMA cannot be performed. Therefore, once the DMA completes transfer, the transfer by the DMA is temporarily stopped before the initialization of the ATA, and the transfer by the DMA is resumed after the initialization of the ATA.

In step S504, a portion of the hibernation image in the non-volatile storage apparatus 603 that has not been read into the memory 600 is read into the memory 600.

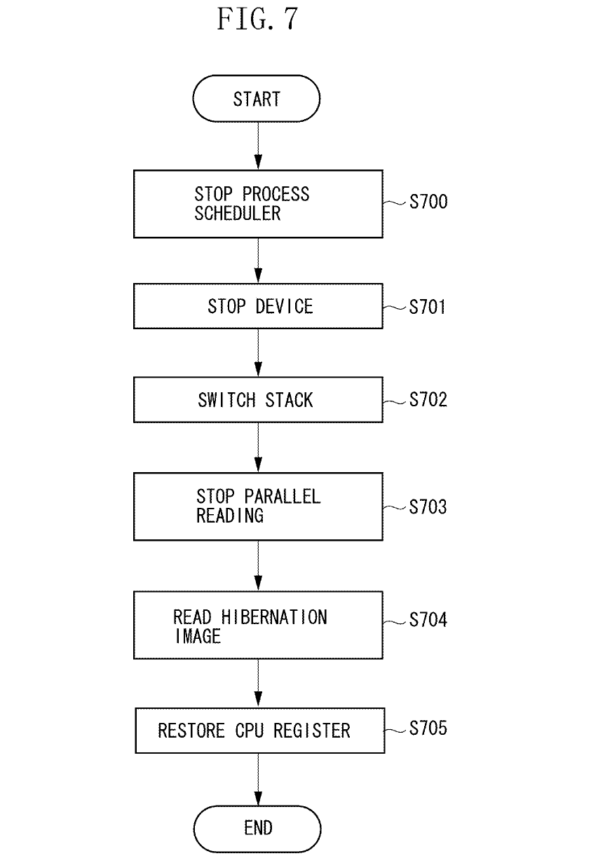

FIG. 7 illustrates details of processing instep S504 and is a flow of processing for restoring the hibernation image according to the present exemplary embodiment. In step S700, the process scheduler is stopped. In step S701, the device is stopped. In step S702, a stack is changed. In step S703, the parallel reading by the DMAC is stopped. In step S704, the CPU 101 reads the hibernation image. In step S705, the CPU register is restored.

In step S702, a stack for initializing the kernel is switched to that for restoring the hibernation image. The stack for restoring the hibernation image is specified in the memory area that is not used while the hibernation image is being restored so that the content thereof is not overwritten during the restoration. In step S705, the stack is restored.

In step S703, the processing is made to wait until the DMAC in operation is stopped. When the parallel reading has been already completed, the processing is not made to wait.

In step S704, a portion of the hibernation image that is to be read but has not been read yet into the kernel non-management area and a portion of the hibernation image to be read into the kernel management area are read. This processing is repeated until a counter of data that the DMA completes transfer becomes equal to the total data amount 402.

In step S705, the processing is performed within the special function. First, if a translation look-aside buffer (TLB) is included, TLB flash is performed. To perform the TLB flash by the x86 processer, a value of a CR3 register is once saved to another register, and then the CR3 register is overwritten with the saved value again. The data is restored to the general-purpose data register from the valuable used when being saved into the CPU. Further, the swap data swapped out to the non-volatile storage apparatus 202 is also restored.

On returning from the above-described function, the data can be restored to the same state as that immediately after step S303 except for the hibernation global variable and the unused area of the memory. Instep S304, since the hibernation image is not being created (NO in step S304), the processing proceeds to step S308. The hibernation global variable is used for the above-described determination. In step S308, each device is resumed. In step S309, the processing scheduler is resumed, and then hibernation start-up is completed.

The data swapped out in step S302 is read into the memory from the storage after the system is restored. For example, as with the swap mechanism included in Linux (registered trademark), the swapped data is written back to the memory according to generation of a page fault. If all the hibernation images can be transferred to the memory in parallel with the initialization of the kernel, the processing in step S703 can be skipped, and the kernel management area may be released by a memory management function of the kernel.

According to the present exemplary embodiment as described above, when the system is started again using the hibernation image, the portion of the hibernation image can be read in parallel with the initialization by the kernel, so that the system can be restored at higher speed than that by the conventional method. Further, according to the present exemplary embodiment, a time required for the memory management mechanism to initialize the memory by can be reduced in the hibernation start-up.

Further, the present invention can be realized by executing the following processing. More specifically, software (a program) for realizing the functions of the above exemplary embodiment is supplied to a system or an apparatus via a network or various storage media and a computer (or a CPU or a micro processing unit (MPU)) of the system or the apparatus reads and executes the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-125345 filed Jun. 3, 2011, which is hereby incorporated by reference herein in its entirety.

What is claimed is:

1. An information processing apparatus comprising:
a volatile memory;
a non-volatile memory configured to store hibernation information; and
a reading unit configured to, in parallel with initialization of a kernel expanded in the volatile memory, read a part of the hibernation information stored in the non-volatile memory into an area that is not used for initialization of the kernel.

2. The information processing apparatus according to claim 1, wherein the reading unit reads the rest of the hibernation information into the volatile memory to start a system after initialization of the kernel.

3. The information processing apparatus according to claim 1, further comprising a memory management unit configured to assign the volatile memory a kernel management area that is used to initialization of the kernel and a kernel non-management area that is not used to initialization of the kernel.

4. The information processing apparatus according to claim 1, further comprising a startup unit configured to perform control to normally start the information processing apparatus if the hibernation information is not saved in the non-volatile memory.

5. The information processing apparatus according to claim 1, further comprising a saving unit configured to save the hibernation information in the non-volatile memory.

6. The information processing apparatus according to claim 5, wherein the saving unit saves the hibernation information in a file with a format not depending on a file system to the non-volatile memory.

7. The information processing apparatus according to claim 3, wherein the memory management unit sets a size of the kernel management unit to a minimum size required for initialization of the kernel or more.

8. The information processing apparatus according to claim 1, wherein the reading unit includes a direct memory access (DMA) controller, and reads the hibernation information stored in the non-volatile memory into the area that is not used for initialization of the kernel.

9. A method for processing information executed in an information processing apparatus including a volatile memory and a non-volatile memory storing hibernation information, the method comprising;
reading, in parallel with initialization of a kernel expanded in the volatile memory, a part of the hibernation information stored in the non-volatile memory into an area that is not used for initialization of the kernel.

10. A non-transitory computer-readable storage medium storing a computer program causing a computer including a volatile memory and a non-volatile memory storing hibernation information to function as a reading unit configured to, in parallel with initialization of a kernel expanded in the volatile memory, read a part of the hibernation information stored in the non-volatile memory into an area that is not used for initialization of the kernel.
